(19) United States
(12) Patent Application Publication
(10) Pub. No.: US 2005/0025848 A1
(43) Pub. Date: Feb. 3, 2005

(54) Air filter shaping mold

(76) Inventors: Ruey-Fa Huang, Sioushuei Township (TW); Tsung-Min Huang, Sioushuei Township (TW)

Correspondence Address: TROXELL LAW OFFICE PLLC, SUITE 1404, 5205 LEESBURG PIKE, FALLS CHURCH, VA, 22041, US

(21) Appl. No.: 10/629,867

(22) Filed: Jul. 30, 2003

(51) Int. Cl. B29C 70/76

(52) U.S. Cl. 425/116; 425/112; 249/95

(57) ABSTRACT

An air filter-shaping mold includes an upper and a lower mold base combined together. The upper and the lower mold base are respectively formed with plural curved separating plates. A filter material having the same shape as the separating plates is placed on the separating plates of the lower mold base for carrying out forming of an air filter, able to save labor and time in making molds and cost on material, to position the filter material precisely, to elevate production efficiency and to stabilize quality of products.

### BACKGROUND OF THE INVENTION

1. Field of the Invention

This invention relates to an air filter shaping mold, particularly to one having excellent efficiency in processing, provided with less components and able to form an air filter with one round of processing.

2. Description of the Prior Art

A conventional air filter shaping mold, as shown in FIG. 1, includes an upper, an intermediate and a lower mold base 11, 12 and 13 combined together. The upper and the lower mold base 11, 13 respectively and correspondingly have plural projecting separating plates 111, 131 provided spaced apart equidistantly and interposing each other, and the intermediate mold base 12 is formed with a through cavity 121 in the center. After combined together, the intermediate mold base 12 is firmly sandwiched between the upper and the lower mold base 11, 13, and the projecting separation plates 111, 131 of the upper and the lower mold base 11, 13 are positioned in the cavity 121 of the intermediate mold base 12.

To integrally form an air filter 14 by means of the conventional shaping mold 10, the intermediate mold base 12 is first assembled closely on the lower mold base 13, and then a plane filter cotton sheet 141 is placed on the upper side of the lower mold base 13. Next, the upper mold base 11 is closely compressed on the intermediate and the lower mold base 12, 13, and simultaneously, the projecting separating plates 111, 131 of the upper and the lower mold base 11 and 13 are arranged interposing each other to compress the filter cotton sheet 141 into continuous curves spaced apart equidistantly. Subsequently, raw material of rubber is poured into the cavity 121 of the intermediate mold base 12 by an injection device through the pouring passage 15 and the pouring gate 16 of the upper mold base 11 to form a gelatin frame 142 covering up the outer circumferential edge of the filter cotton sheet 141. Lastly, the upper, the intermediate and the lower mold base 11, 12, 13 are orderly separated from one another and the finished product of an air filter 14 is removed out and then the intermediate mold base 12 is again assembled on the lower mold base 13, thus obtaining an integrally formed air filter.

Although the conventional air filter-shaping mold 10 can integrally form an air filter 14, yet the forming process is too complicated and inconvenient, and substantially the finished products are imperfect in quality. The reasons for these drawbacks are described below.

1. To integrally form an air filter, it is necessary to use the upper, the intermediate and the lower mold base 11, 12 and 13 at the same time, wasting much labor and time in making molds and much cost on material. Besides, in a forming process, precision of combination of the three mold bases must be taken into consideration, because it may greatly influence the external appearance of finished products.

2. In a forming process, the filter cotton sheet 141 is directly made into continuous curves by the projecting separation plates 111, 131 of the upper and the lower mold base 11 and 13. Nevertheless, the upper and the lower mold base 11, 13 are fixed on the injection device which has no auxiliary apparatus for fixedly positioning the filter cotton sheet 141; therefore the filter cotton sheet 141 may deflect and shift sideways when the upper mold base 11 is closely assembled on the lower mold base 13. If the filter cotton sheet 141 is excessively deflected, its outer end 143 may shrink inward and fail to be bonded with the frame 142, possible to render the entire filter cotton sheet 141 inclined on one side and hence influence the quality of products.

### SUMMARY OF THE INVENTION

The objective of the invention is to offer an air filter-shaping mold composed of an upper and a lower mold base. The lower mold base is formed with a plurality of projecting separating plates, and a filter material of a preset shape is positioned on these separating plates for carrying out forming of an air filter, saving labor and time in making molds and cost on material, positioning the filter material precisely and stabilizing quality of products.

### BRIEF DESCRIPTION OF DRAWINGS

This invention will be better understood by referring to the accompanying drawings, wherein:

FIG. 1 is a partial exploded perspective view of a conventional air filter-shaping mold:

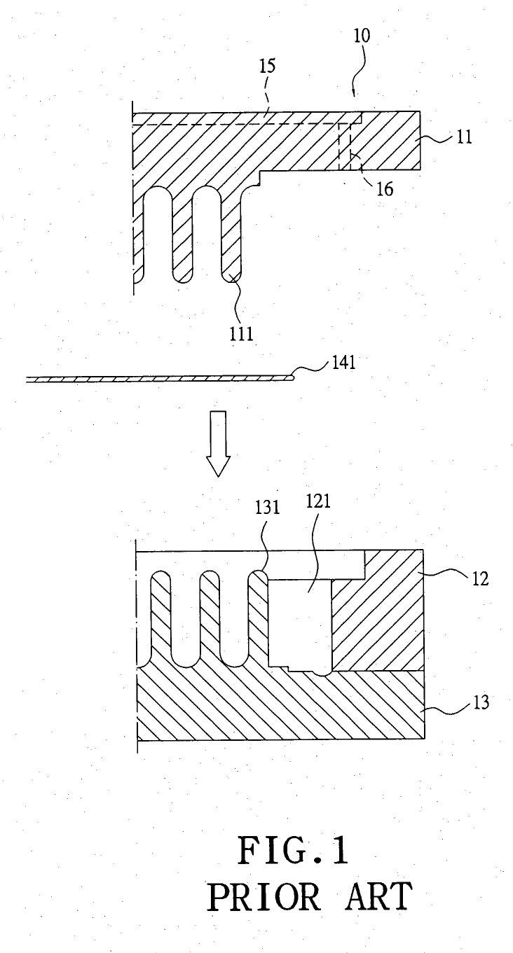

FIG. 2 is a cross-sectional view of the conventional air filter-shaping mold having its three mold bases combined together:

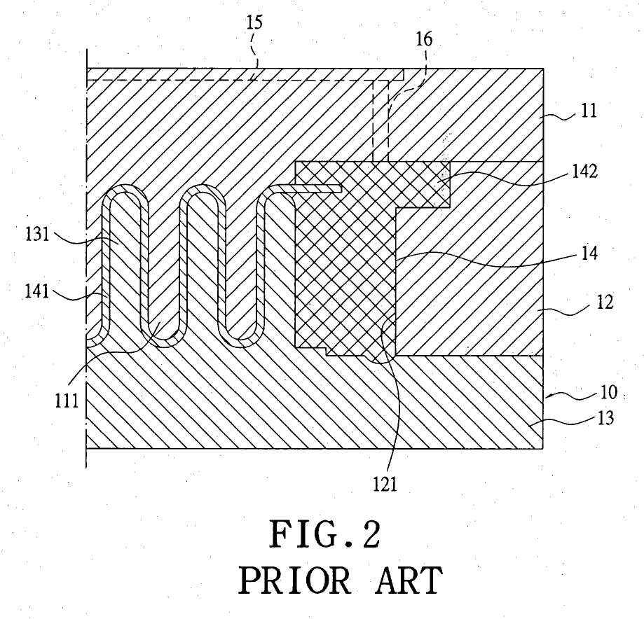

FIG. 3 is a cross-sectional view of the conventional air filter-shaping mold having its three mold bases opened and separated:

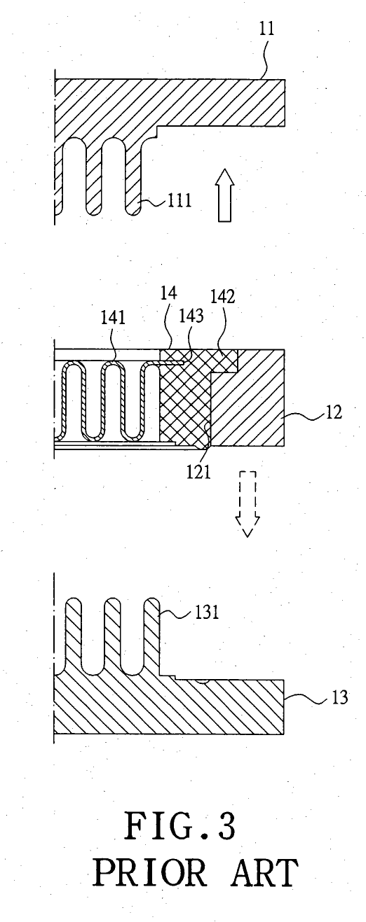

FIG. 4 is an exploded perspective view of a first preferred embodiment of an air filter-shaping mold in the present invention:

FIG. 5 is a partial perspective view of the first preferred embodiment of the upper mold base of the air filter-shaping mold in the present invention:

FIG. 6 is a partial exploded and cross-sectional view of the first preferred embodiment of the air filter-shaping mold in the present invention:

FIG. 7 is a cross-sectional view of the first preferred embodiment of the air filter-shaping mold in the present invention, showing two mold bases combined together:

FIG. 8 is a cross-sectional view of the first preferred embodiment of the air filter-shaping mold in the present invention, showing the two mold bases combined together and poured therein with raw material of rubber:

FIG. 9 is an exploded and cross-sectional view of the first preferred embodiment of the air filter-shaping mold in the present invention, showing the two mold bases opened and separated after an air filter is formed:

FIG. 10 is a perspective view of the air filter formed by the air filter-shaping mold of the first preferred embodiment in the present invention: and

FIG. 11 is a partial cross-sectional view of a second preferred embodiment of an air filter-shaping mold in the present invention.

### DETAILED DESCRIPTION OF THE PREFERRED EMBODIMENT

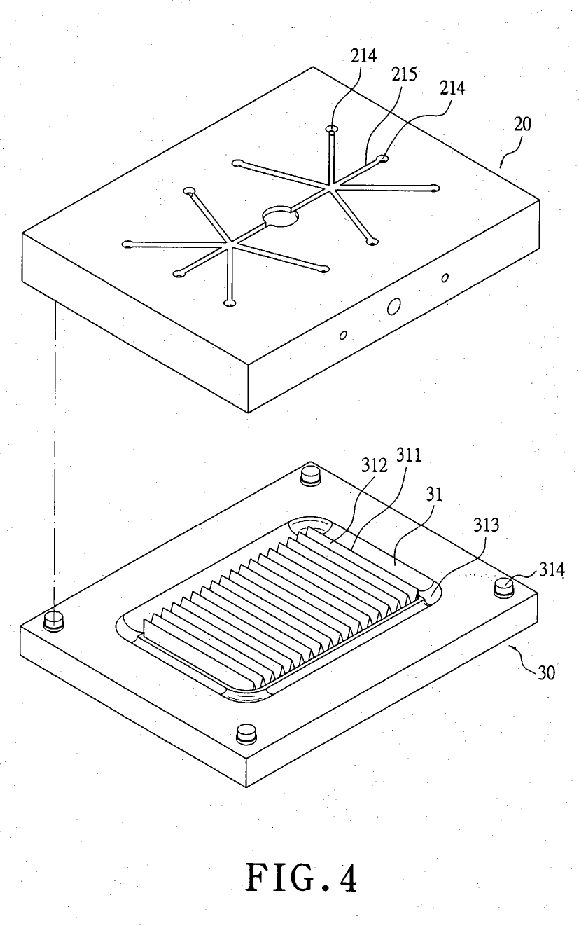

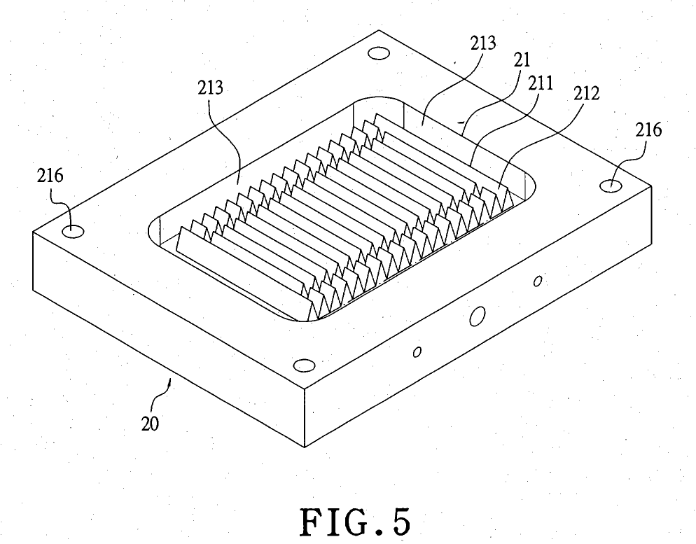

A first preferred embodiment of an air filter-shaping mold in the present invention, as shown in FIGS. 4, 5 and 6, includes an upper mold base 20 and a lower mold base 30 combined together.

The upper mold base 20 is a rectangular body having its lower side bored with an upper cavity 21 of a preset depth. The cavity 21 has its bottom side formed with a plurality of triangular separating plates 211 protruding downward and spaced apart equidistantly, and between every two separating plates 211 is formed a triangular upper accommodating groove 212. An annular groove 213 of a preset width is formed between all the separating plates 211 and the circumferential edge of the upper cavity 21 and has plural through pouring holes 214 bored at preset locations in an upper surface and communicating to the topside of the upper mold base 20. The upper mold base 20 further has its upper surface bored with plural pouring passages 215 communicating with one another and with the pouring holes 214 to pour raw material therein and guide it to get into and fill up the annular groove 213 through the pouring holes 214, with some pouring gates 214 positioned close to the four corners of the annular groove 213. Besides, the upper mold base 21 has four combining hole 216 respectively provided at four corners of the bottom.

The lower mold base 30 to be assembled with the bottom side of the upper mold base 20 is bored in the upper side with a lower cavity 31 having its bottom formed with a plurality of triangular separating plates 311 protruding upward and spaced apart equidistantly, and between every two separating plates 311 is formed a triangular lower accommodating groove 312. Thus, when the upper and the lower mold base 20, 30 are combined together, the separating plates 211, 311 of the upper and the lower mold base 20 and 30 can be interposed with one another and positioned in the accommodating grooves 312, 212 of the lower and the upper mold base 30, 20. In addition, an annular groove 313 of a preset width is formed between all the separating plates 311 and the circumferential edge of the lower cavity 31. The annular groove 313 of the lower cavity 31 is formed with an arc-shaped surface and matches with the annular groove 213 of the upper cavity 21. The lower mold base 30 further has four combining studs 314 respectively fixed at four corners of the upper surface to be respectively inserted in the four combining holes 216 of the upper mold base 20.

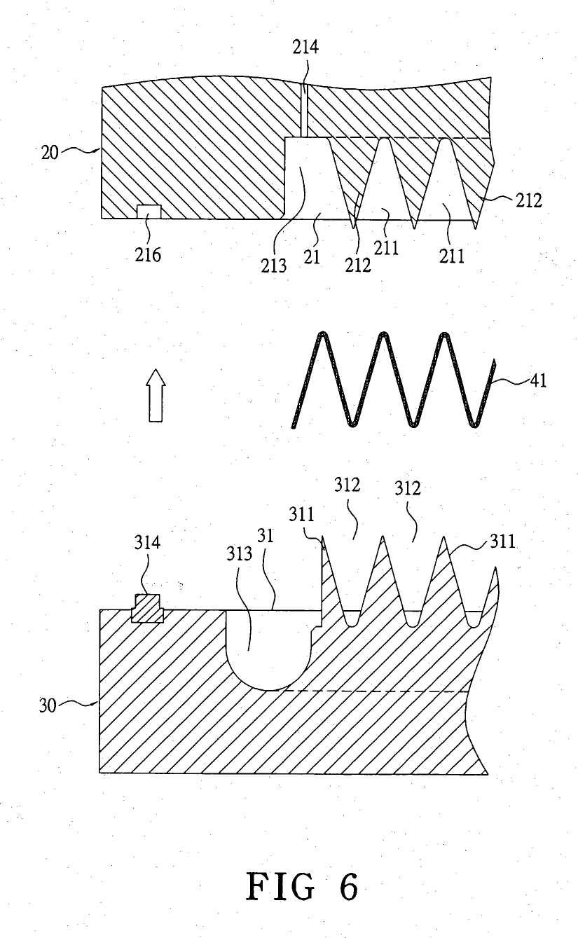

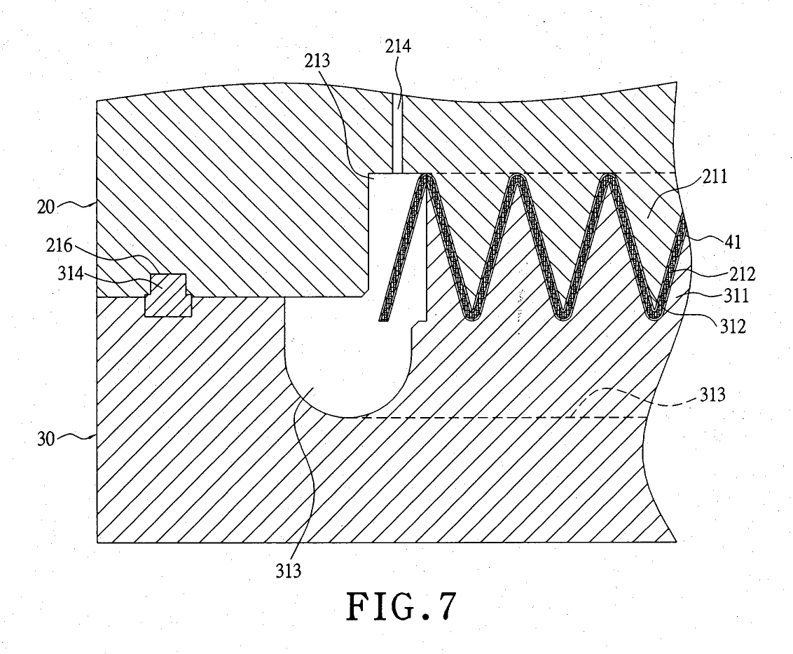

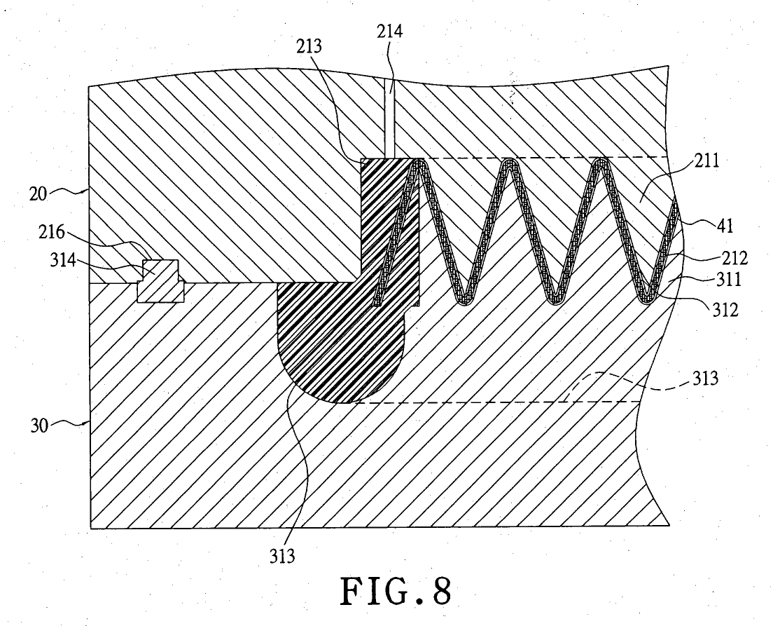

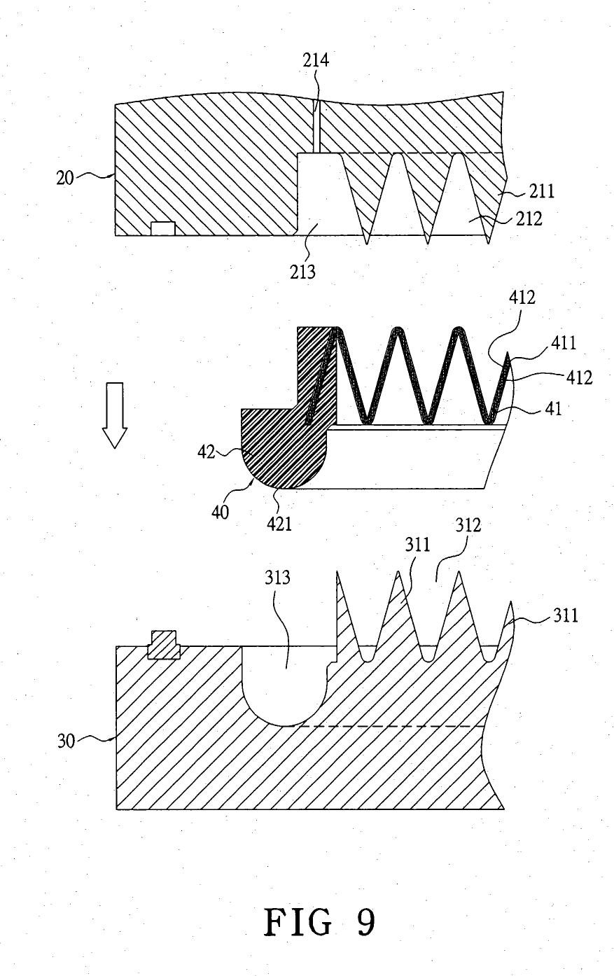

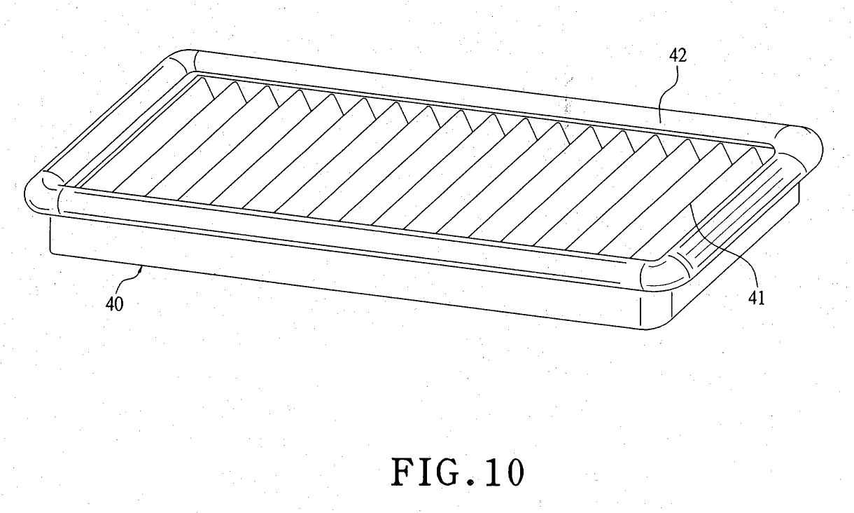

To carry out forming of an air, as shown in FIGS. 6 and 7, the air filter shaping mold is installed on an injecting device in advance, and a filter material 41 formed in advance with continuous saw teeth is deposited on the separating plates 311 of the lower cavity 31, and then the upper and the lower mold base 20, 30 are combined together. At this time, the separating plates 211 in the upper cavity 21 and the separating plates 311 in the lower cavity 31 are interposed with one another to clamp and compress the filter material 40. Then, as shown in FIG. 8, raw material of rubber is poured into the annular grooves 213, 313 of the upper and the lower cavity 21, 31 through the pouring passages 215 and the pouring holes 214 by the injection device, and the raw material of rubber is then covered on and bonded with part of the circumferential edge of the filter material 41 to form the outer frame 42 of an air filter 40. After finishing pouring the raw material into the annular grooves 213, 313 and forming the frame 42 of an air filter, the upper and the lower mold base 20, 30 are opened and separated, and the finished product of an air filter 40 is removed out, thus finishing forming integrally an air filter 40 having a great strength and stable quality, as shown in FIGS. 9 and 10.

The filter material 41 in the first preferred embodiment is composed of a filter fabric 411 and metallic gauze 412. The filter fabric 411 is a non-woven fabric or cotton cloth having function of air filtering, and the metallic gauze 412 is covered on the surfaces of the filter fabric 411 so as to strengthen the whole structure of the filter material 41. In addition, the filter material 41 can be metallic gauze made of stainless steel or a filter fabric or the like to meet different demands of customers. Furthermore, the annular groove 313 of the lower cavity 31 of the lower mold base 30 is formed with an arc-shaped surface; thus, after the frame 42 of an air filter 40 is formed, its upper edge can be formed with a current guiding surface 421 of a preset radian, which is able to smoothly guide air to move downward and pass through the filter material to be filtered, able to decrease reflected current of air and increase quantity of air sucked into the engine for use, as shown in FIG. 9.

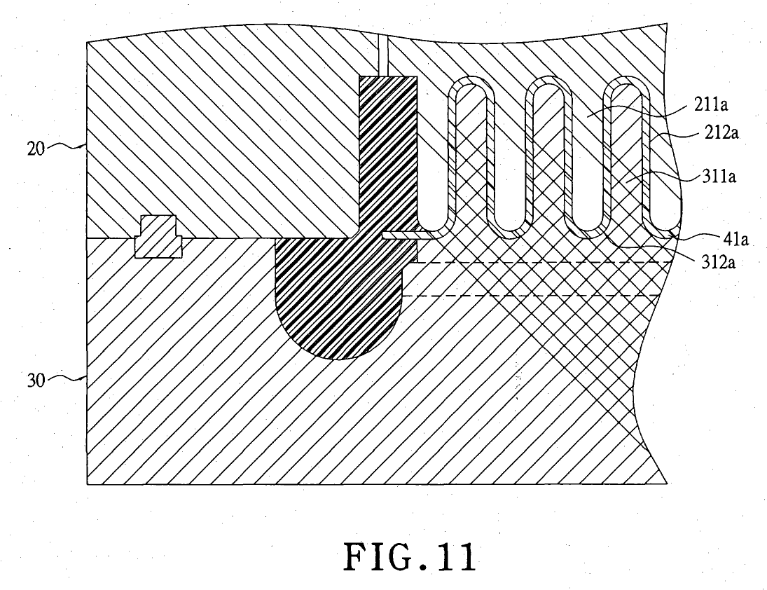

A second preferred embodiment of an air filter shaping mold in the present invention, as shown in FIG. 11, includes an upper and a lower mold base 20, 30 combined together. The upper and the lower mold base 20, and 30 are respectively formed inside with a plurality of pillar-shaped separating plates 211a, 311a having their ends respectively formed with an arc-shaped surface, and between every two pillar-shaped separating plates 211a, 311a is formed a pillar-shaped groove 212a, 312a. And a filter material 41a is formed with continuous curves to match with the pillar-shaped separating plates 211a, 311a. Although the shapes of the separating plates and the accommodating grooves in the second preferred embodiment are different from those in the first preferred embodiment, yet these two kinds of air filter shaping molds have equal effect in forming of a high-quality air filter.

To sum up, this invention has the following advantages.

1. The air filter shaping mold in the invention can form an air filter with one round of processing only by employing an upper and a lower mold base, having fewer components than the conventional air filter shaping mold and hence able to save cost on molds and material.

2. The air filter shaping mold in the invention only includes an upper and a lower mold base; therefore in the forming process of an air filter, these two mold bases can be combined or opened and separated quickly and conveniently, greatly elevating production efficiency.

3. The filter material is formed in advance with continuous curves to match with the curved separating plates in the upper and the lower cavity; therefore the filter material can be quickly and stably positioned in the cavities to prevent it from deflecting and shifting sideways when the two mold bases are combined together, able to make the filter material and the frame bonded together precisely to enhance quality of products.

While the preferred embodiments of the invention have been described above, it will be recognized and understood that various modifications may be made therein and the appended claims are intended to cover all such modifications that may fall within the spirit and scope of the invention.

1. An air filter shaping mold comprising:
An upper mold base having its lower side formed with an upper cavity of a preset depth, said upper cavity formed with a plurality of separating plates equidistantly protruding downward from the bottom, between every two said separating plates formed a groove, an annular groove of a preset width formed between all said separating plates and the circumferential edge of said upper cavity, said annular groove having plural through pouring holes bored at preset locations and communicating to the upper surface of said upper mold base, said upper mold base having its upper surface bored with plural pouring passages communicating with one another and with said pouring holes, said pouring passages guiding raw material to get in and fill up said annular groove through said pouring holes, said upper mold base further having four combining holes respectively bored at four corners of the bottom:
A lower mold base to be combined with the bottom side of said upper mold base, said lower mold base having its topside bored with a lower cavity, said lower cavity provided with a plurality of separating plates equidistantly protruding upward from the bottom, between every two said separating plates formed a groove, said separating plates of said upper and said lower mold base interposing each other and positioned in said upper and said lower cavity when said upper and said lower mold base are combined together, an annular groove of a preset width formed between all said separating plates and the circumferential edge of said lower cavity, said annular groove of said lower cavity matching with said annular groove of said upper cavity, said lower mold base further having four combining studs respectively fixed at four corners of the upper surface, said four combining studs of said lower mold base respectively inserted in said four combining holes of said upper mold base: and
A filter material formed in advance with continuous curves placed on said separating plates of said lower cavity, raw material poured in said pouring passages after said upper and said lower mold base are combined together, said raw material filling up said annular grooves of said upper and lower cavity, said raw material also covering and bonding part of the circumferential edge of said filter material to form the outer frame of an air filter, thus integrally forming an air filter of a great strength.

2. The air filter shaping mold as claimed in claim 1, wherein said separating plates of said upper and said lower cavity and said grooves formed between said separating plates are respectively triangle-shaped.

3. The air filter shaping mold as claimed in claim 1, wherein said raw material to be poured in said mold is rubber.

4. The air filter shaping mold as claimed in claim 1, wherein said filter material is composed of a filter fabric and a metallic gauze, and said filter fabric is a non-woven fabric or cotton cloth having function of air filtering, said metallic gauze covering and clamping the surface of said filter fabric to strengthen the structure of said filter material.

5. The air filter shaping mold as claimed in claim 1, wherein said filter material is a metallic gauze made of stainless steel so it has a strengthened structure and can be cleaned easily and employed repeatedly.

6. The air filter shaping mold as claimed in claim 1, wherein said separating plates of said upper and said lower cavity are respectively shaped as a pillar having its end formed with an arc-shaped surface, and said grooves formed between said separating plates are respectively pillar-shaped.

7. The air filter shaping mold as claimed in claim 1, wherein said annular groove of said lower cavity has its upper side formed with an arc-shaped surface, so that the frame of an air filter, after formed in said shaping mold, has its upper edge formed with a current guiding surface of a preset radian.
